(19) United States
(12) Patent Application Publication
(10) Pub. No.: US 2008/0026769 A1
(43) Pub. Date: Jan. 31, 2008

(54) MOBILITY TRACKING METHOD AND SYSTEM

(75) Inventor: Carl A. Braam, Chapel Hill, NC (US)

Correspondence Address: CANTOR COLBURN LLP - IBM RSW, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/460,124

(22) Filed: Jul. 26, 2006

(51) Int. Cl. H04Q 7/20

(52) U.S. Cl. 455/456.1

(57) ABSTRACT

A method for a user to monitor the location of a subject is disclosed. The method includes defining a timetable of allowable location vectors for the subject via a central control computer, specifying a phone number associated with the user, and transferring the timetable of allowable location vectors to a control module of a cellular telephone. The method continues with monitoring the current location via a global positioning device within the cellular telephone, comparing a combination of current location and time to the timetable of allowable location vectors; and determining if the combination of current location and time satisfy the timetable of allowable location vectors. In response to determining that the combination of current location and time violate the timetable of allowable location vectors, contacting the central control computer; and establishing a communication link, via the central control computer, between the cellular telephone and the specified phone number.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to positioning, and particularly to the tracking of position.

2. Description of Background

Often, children and some elderly people don't know if they are going somewhere they shouldn't. There are tracking products available, but they typically require a user to have access to a computer, and to actively monitor via the computer the location status of a subject in order to be assured that the subject is located as desired. Accordingly, the state of the art will be advanced by a system that overcomes these drawbacks.

### SUMMARY OF THE INVENTION

The shortcomings of the prior art are overcome and additional advantages are provided through the provision of a mobility alert system that notifies a user when a subject has gone outside of a predefined, permitted area.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution that will notify a user if a subject's location is outside of an area that has been defined to be allowed, and provide a direct communication link between the user and the subject.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a mobility alert system in accordance with an embodiment of the invention.

FIG. 2 illustrates one example of a method for a user to monitor the location of a subject in accordance with an embodiment of the invention.

FIG. 3 illustrates one example of a back view of a cellular phone for use with a mobility alert system in accordance with an embodiment of the invention.

The detailed description explains the preferred embodiments of the invention, together with advantages and features, by way of example with reference to the drawings.

### DETAILED DESCRIPTION OF THE INVENTION

Having a cost effective method to track the location of a subject and remind the subject of departure outside of an allowable location in real time would be beneficial to parents (and children of elderly parents). An embodiment of the invention will provide a method to use a combined cell phone and GPS with a central control computer to immediately establish a communication link between a user and the subject if the subject is located outside of a predefined permitted area at a specific time. As used herein, the term “user” shall refer to a person whom would like to be made aware if another person, herein referred to as a “subject”, fails to be present within a permitted location at a specific time.

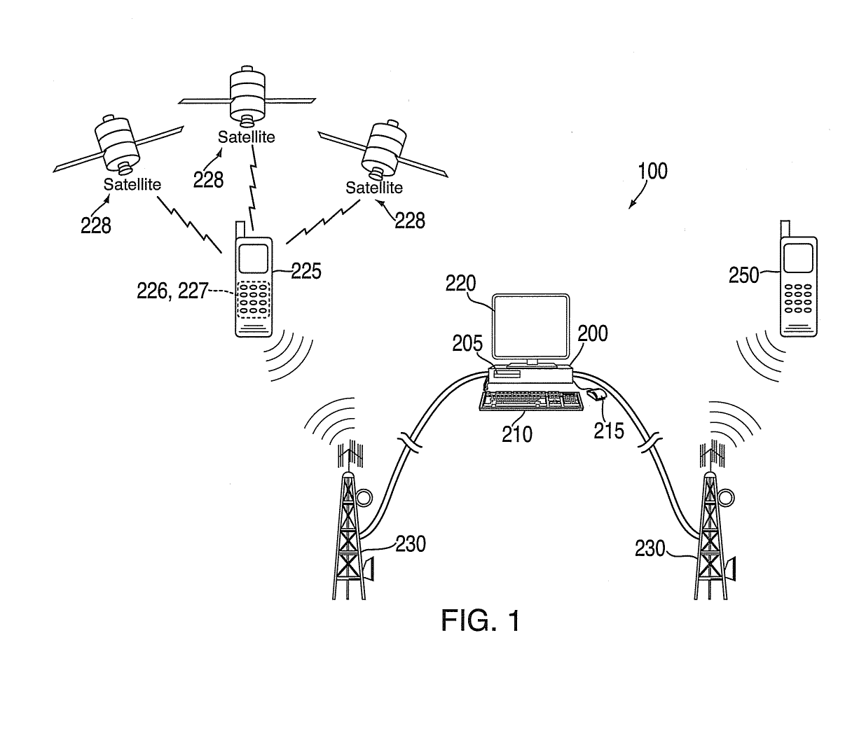

Referring now to FIG. 1, an exemplary embodiment of a mobility alert system 100 is depicted. The mobility alert system comprises a central control computer 200, a cellular telephone 225, cellular radio transmission towers 230, and a user phone 250. The central control computer 200 further comprises a program storage device 205, input devices 210, 215, and an output device 220.

In an embodiment, the central control computer 200 is configured to define a timetable of allowable location vectors for the subject. The timetable of allowable location vectors establishes a rule-based monitoring by defining specific combinations of location and time that are allowable. In an embodiment, the central control computer 200 will run software to identify and manage a location database that stores the timetable of allowable location vectors. For example, if the subject to be monitored is a child, the user may define the allowable location vectors to be that of a school during school hours, a playground for a subsequent period of time, with home as the final allowable location. In an embodiment, the central control computer 200 is capable to make changes to both the location vectors and the time schedule, thereby editing the timetable of allowable location vectors. In an embodiment, the central control computer 200 is configured to allow the user to specify a phone number of the user phone 250 to be contacted in the event that the subject violates the timetable of allowable location vectors.

In an embodiment, the cellular telephone 225 is configured to be carried by the subject, and comprises a control module disposed within the cellular telephone 225, the control module represented by hidden line 226. In an embodiment, the control module 226 further comprises a global positioning device 227. The control module 226 is configured to receive and store the timetable of allowable location vectors defined by the central control computer 200. The control module 226 is also configured to monitor a combination of current location and time of the cellular telephone 225 and to compare the combination of current location and time to the timetable of allowable location vectors. In an embodiment, the global positioning device 227 will determine location of the cellular telephone 225 in conjunction with a group of Earth-orbiting satellites 228, in a manner well-known as a global positioning system (GPS). In an embodiment, the central control computer 200 is configured to automatically transfer the timetable of allowable location vectors to the control module 226 on a periodic basis.

In an embodiment, the central computer 200 is configured to define more than one timetable of allowable location vectors for more than one subject, and thereby support the use of multiple cellular telephones 225 to be carried by multiple subjects.

In an embodiment, the software running on the central control computer 200 will contain GPS mapping software to build the necessary location vector database to provide the timetable of allowable location vectors. In an embodiment, the control module 226 is configured to store the timetable of allowable location vectors and continuously track the location of the cellular telephone 225 in the absence of a connection between the cellular telephone 225 and the central control computer 200.

In an embodiment, in response to determining that the combination of current location and time violate the timetable of allowable location vectors, the control module 226 is configured to contact the central control computer 200. To contact the central control computer 200, the cellular telephone 225 will establish a radio communication with the cellular radio transmission towers 230, which will then establish a land-line based telephone connection with the central control computer 200, in a well-known manner.

While an embodiment of the invention has been described using a combination of cellular and land-line based telephone contact between the cellular telephone 225 and the central control computer 200, it will be appreciated that the scope of the invention is not so limited, and that the invention will also apply to other means of contact between the cellular telephone 225 and the central control computer 200, such as a direct radio connection, for example.

In an embodiment, in response to being contacted by the control module 226 of the cellular telephone 225, the central control computer 200 is configured to act as real-time router to establish a communication link between the cellular telephone 225 and the specified phone number of the user phone 250. In an embodiment, the central control computer 200 will contact the user phone 250 via a land-line based connection. In another embodiment, the central control computer 200 will contact the user phone 250 via a cellular telephone connection.

In an embodiment, the control module 226 is configured to provide a periodic notification of location to the central control computer 200 at periods that are user-specified. In response to a failure by the central control computer 200 to receive a periodic notification of location from the cellular telephone 225, the central control computer 200 is configured to contact the specified phone number of the user phone 250, in order to notify the user of the lack of contact between the cellular telephone 225 and the central control computer.

In an embodiment, in response to a failure to establish a communication link between the cellular telephone 225 and the specified phone number associated with the user phone 250, the central control computer 200 is configured to establish a communication link between the cellular telephone 225 and at least one of a set of alternate phone numbers in a user-specified list, also known as a “chain of command”, to ensure that contact is made. In an embodiment, the set of alternate phone numbers are exclusive of the specified phone number associated with the user phone 250, and are stored within the central control computer 200. The central control computer 200 is configured to continue to attempt to contact the alternate phone numbers within the “chain of command” list in an order specified by the user until a connection is established.

In an embodiment, in response to a failure by the control module 226 to contact the central control computer 200, the control module 226 continues to monitor location with the last known timetable of allowable location vectors. Further, in response to a failure by the control module 226 to contact the central control computer 200 during a violation, the control module 226 will attempt to establish a direct communication link with the specified phone number of the user phone 250. In response to a failure to establish a direct communication link between the cellular telephone 225 and the specified phone number of the user phone 250, the control module 226 is configured to attempt to establish a direct communication link with at least one of the set of the numbers within the “chain of command” list.

While an embodiment of the invention has been described depicting the user phone 250 as a cellular telephone, it will be appreciated that the scope of the invention is not so limited, and that the invention will also apply to other means of user to subject communication, such as a land-line based phone, a text-pager, or any other means of contact and communication, for example.

Additionally, in an embodiment the control module 226 is configured to store a history of the combination of location and time information of the cellular telephone 225 and to transfer the history to the central control computer 200 for logging. Accordingly, the central control computer 200 is configured to provide the user with means for reviewing and reporting on location log entries generated by the control module 226 to be used for trend and other analysis. In another embodiment, in response to the control module 226 determining that the combination of current location and time violate the timetable of allowable location vectors, the cellular telephone 225 will transfer the combination of location and time information to the central control computer 200 for logging.

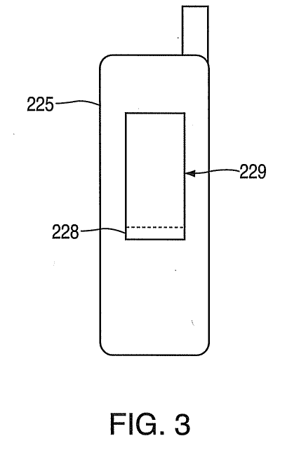

Referring now to FIG. 3, a back view of the cellular telephone 225 is depicted. In an embodiment, to ensure that the cellular telephone 225 remains in the possession of the subject, and will not be removed or left at a particular location, a switch 228 is integrated with a clip 229 disposed on the back of the cellular telephone 225. The switch 228 is configured to immediately contact the user phone 250, via the central control computer 200, if the cellular telephone 225 is removed from the subject, thereby ensuring that the cellular telephone 225 remains with the subject. In another embodiment, the central control computer 200 is configured to periodically dial the cellular telephone 225 and require the subject to enter a code. In yet another embodiment, the cellular telephone 225 is configured to periodically require the subject to enter a code prior to contact with the central control computer 200. For example, the cellular telephone 225 may be programmed to provide a reminder beep every hour to have the subject enter a private code.

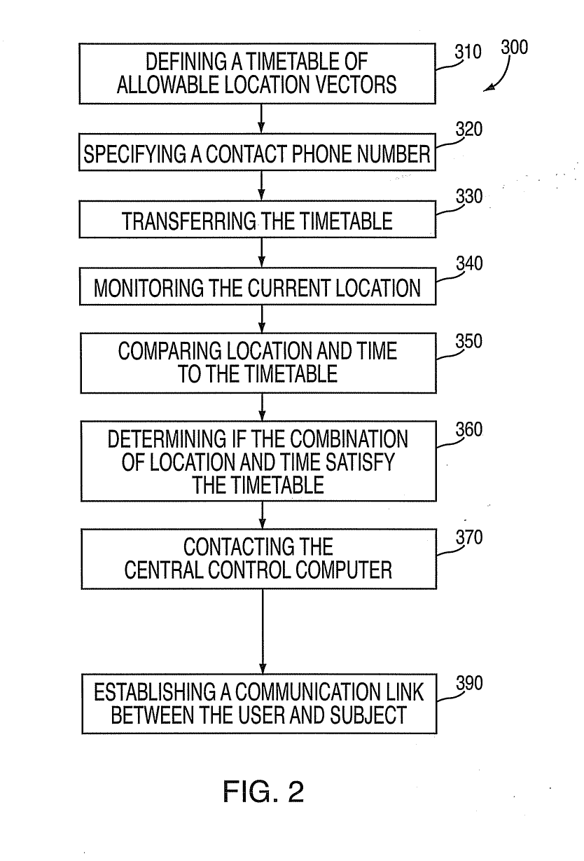

In view of the foregoing, the mobility alert system performs a method of location monitoring of the subject by the user. Referring now to FIG. 2, a flowchart 300 as an embodiment of the method of location monitoring is depicted.

The method begins with defining 310 the timetable of allowable location vectors for the subject and specifying 320 the phone number associated with the user via the central control computer 200. The method proceeds with transferring 330 the timetable of allowable location vectors to the control module 226 of the cellular telephone 225, the control module 226 comprising the global positioning device 227. Following the transferring 330, monitoring 340 the current location of the cellular telephone 340 via the global positioning device 227. In an embodiment, defining the timetable of allowable location vectors comprises building the timetable of allowable location vectors via global positioning system mapping software.

In an embodiment, the method continues by comparing 350 the combination of the current location and time of the cellular telephone 225 to the timetable of allowable location vectors and determining 360 if the combination of current location and time satisfy the timetable of allowable location vectors.

In an embodiment, in response to determining 360 that the combination of current location and time violate the timetable of allowable location vectors, that is, determining 360 that the subject occupies a non-allowed location at a specific time (as defined by the timetable of allowable location vectors), the control module 226 will cause the cellular telephone 225 to respond by contacting 370 the central control computer 200. The central control computer 200 is configured to respond to the contact 370 by establishing 390 a communication link between the cellular telephone 225 and the specified phone number of the user phone 250. This will allow the user to speak directly with the subject, and ensure that the subject is aware of the subject's expected location at that particular time. This direct communication link will also allow the user to determine if the subject requires any assistance, and contact additional parties as may be deemed appropriate by the user. In an embodiment, the central control computer 200 is configured to respond to the contact 370 of the control module 226 by logging the combination of location and time information gathered by the control module 226.

In an embodiment, in response to failing to establish 390 a communication link between the cellular telephone 225 and the specified phone number of the user phone 250 via the control computer 200, establishing a communication link, via the central control computer 200, between the cellular telephone 225 and at least one of the set of alternate phone numbers in the user-specified list. The user specified list may be known as the “chain of command”. The attempting to establish the communication link with at least one of the set of alternate phone numbers will be processed in the order specified by the user.

In an embodiment, in response to failing to receive a periodic notification of location at the central control computer 200 from the control module 226, the central control computer will respond by contacting the specified phone number of the user phone 250.

In an embodiment, the comparing 350 and determining 360 are performed by the control module 226 without involvement of the user. For example, the user is not required to monitor any screens of the central control computer 200 or take any other affirmative action to ensure that subject is in an allowable location. The user may therefore understand that a lack of contact otherwise indicates that the cellular telephone 225, and thus, the subject, is located within an area that has been defined as allowable. This allows the user to be aware of the general location of the subject without the need to check, monitor, or otherwise access the central control computer 200. Additionally, in an embodiment, the central control computer 200 is configured to respond to a request of the user to determine the exact subject location by connecting with the control module 226 to determine the current location of the cellular telephone 225 at any given time.

In an embodiment, in response to the control module 226 failing to contact the central control computer 200 in response to determining 360 that the combination of current location and time violate the timetable of allowable location vectors, establishing the direct communication link between the cellular telephone 225 and the specified phone number of the user phone 250.

In an embodiment, in response to the control module 226 failing to establish the direct communication link between the cellular telephone 225 and the specified phone number of the user phone 250, establishing the direct communication link between the cellular telephone 225 and at least one of the set of alternate phone numbers in the user-specified list. In an embodiment, the set of alternate phone numbers are exclusive of the specified phone number of the user phone 250, and are stored within the control module 226. The attempting to establish the communication link with at least one of the set of alternate phone numbers will be processed in the order specified by the user.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for a user to monitor the location of a subject, the method comprising:
defining a timetable of allowable location vectors for the subject via a central control computer;
specifying a phone number associated with the user;
transferring the timetable of allowable location vectors to a control module of a cellular telephone, the control module comprising a global positioning device;
monitoring the current location of the cellular telephone via the global positioning device;
comparing a combination of current location and time of the cellular telephone to the timetable of allowable location vectors; and
determining if the combination of current location and time satisfy the timetable of allowable location vectors;
wherein the comparing and the determining are performed by the control module without user involvement;
wherein the transferring the timetable of allowable location vectors is performed automatically on a periodic basis; and
wherein in response to determining that the combination of current location and time violate the timetable of allowable location vectors:
contacting the central control computer; and
establishing a communication link, via the central control computer, between the cellular telephone and the specified phone number.

2. The method of claim 1, wherein:
in response to the contacting the central control computer, logging the combination of location and time.

3. The method of claim 1, further comprising:
storing a history of the combination of location and time information of the cellular telephone in the control module; and
transferring to the central computer the history for logging.

4. The method of claim 1, wherein:
in response to failing to establish a communication link between the cellular telephone and the specified phone number, establishing a communication link, via the central control computer, between the cellular telephone and at least one of a set of alternate phone numbers in an order specified by the user.

5. The method of claim 1, wherein:
the defining the timetable of allowable location vectors comprises building the timetable of allowable location vectors via global positioning system mapping software.

6. The method of claim 1, further comprising:
connecting the central control computer with the control module to determine the current location of the cellular telephone at any given time.

7. The method of claim 1, wherein:
in response to failing to contact the central control computer in response to determining that the combination of current location and time violate the timetable of allowable location vectors, establishing a direct communication link between the cellular telephone and the specified phone number.

8. A mobility alert system to allow a user to monitor the location of a subject, the system comprising:
a central control computer configured to define a timetable of allowable location vectors for the subject; and
a cellular telephone configured to be carried by the subject, the cellular telephone comprising a control module, the control module comprising a global positioning device;
wherein the control module is configured to store the timetable of allowable location vectors;
wherein the control module is configured to monitor and compare a combination of current location and time of the cellular telephone to the timetable of allowable location vectors;
wherein in response to determining that the combination of location and time violate the timetable of allowable location vectors, the control module is configured to contact the central control computer; and
wherein in response to contact by the control module to the central control computer, the central control computer is configured to establish a communication link between the cellular telephone and a specified phone number associated with the user.

9. The system of claim 8, wherein:
the control module is configured to continuously track location of the cellular telephone in the absence of a connection with the central control computer.

10. The system of claim 8, wherein:
the central control computer is configured to transfer the timetable of allowable location vectors to the control module.

11. The system of claim 10, wherein:
the central control computer is configured to automatically transfer the timetable of allowable location vectors to the control module on a periodic basis.

12. The system of claim 8, wherein:
the control module is configured to store a history of the combination of location and time information of the cellular telephone.

13. The system of claim 12, wherein:
the control module is configured to transfer the history of the combination of location and time information to the central control computer for logging.

14. The system of claim 8, further comprising:
a clip disposed on the back of the cellular telephone, the clip comprising a switch, the switch configured to ensure that the phone remains with the subject;
wherein the switch is configured to initiate contact with the specified user phone number in response to the clip and cellular phone being removed from the subject.

15. The system of claim 8, wherein:
the cellular telephone is configured to periodically require the subject to enter a code, thereby ensuring that the subject is in possession of the cellular telephone.

16. The system of claim 8, wherein:
the central control computer is configured determine the subject location by connecting with the control module.

17. The system of claim 8, wherein:
in response to a failure to establish a communication link between the cellular telephone and the specified phone number, the central control computer is configured to establish a communication link between the cellular telephone and at least one of a set of alternate phone numbers in an order specified by the user.

18. The system of claim 8, wherein:
in response to a failure to contact the central control computer in response to determining that the combination of location and time violate the timetable of allowable location vectors, the control module is configured to establish a direct communication link with the specified phone number associated with the user.

19. The system of claim 8, wherein:
in response to a failure establish a direct communication link with the specified phone number associated with the user, the control module is configured to establish a direct communication link with the cellular telephone and at least one of a set of alternate phone numbers in an order specified by the user.

20. A program storage device readable by a machine, the device embodying a program or instructions executable by the machine to perform the method of claim 1.
